(19) United States
(12) Patent Application Publication
(10) Pub. No.: US 2004/0114606 A1
(43) Pub. Date: Jun. 17, 2004

(54) Bandwidth allocation

(76) Inventor: Wassim Haddad, Verdun Municipality (CA)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/629,845

(22) Filed: Jul. 30, 2003

(30) Foreign Application Priority Data
Jul. 31, 2002 (GB) 0217806.9

(51) Int. Cl. H04L 12/28

(52) U.S. Cl. 370/395.41

(57) ABSTRACT

A method is provided of allocating bandwidth in a wireless LAN having a plurality of access points, each using the same wireless technology for data communication with users. The method comprises continuously monitoring bandwidth usage by each of the access points, and re-allocating bandwidth from a low bandwidth usage access point to a high bandwidth usage access point.

### BACKGROUND TO THE INVENTION

This invention relates to a method of, and apparatus for, allocating bandwidth in a wireless LAN, and in particular to a method of, and apparatus for, adaptive bandwidth allocation in a wireless LAN using any one of the family of 802.11 standards.

In a communications system, such as one operating using 802.11 wireless technology, a hot spot is an area of high bandwidth connectivity, that is to say an area in which high bandwidth connections can be made.

The aim of the invention is to provide a method of, and apparatus for, monitoring and managing the deployment of a wireless LAN, particularly in a hot spot.

### SUMMARY OF THE INVENTION

The present invention provides a method of allocating bandwidths in a wireless LAN having a plurality of access points each using the same wireless technology for data communication with users, the method comprising the steps of:—

a) continuously monitoring bandwidth usage by each of the access points; and

b) re-allocating bandwidth from a low bandwidth usage access point to a high bandwidth usage access point.

Preferably, the access points each use the 802.11 wireless technology.

In a preferred embodiment, the 802.11 wireless technology uses direct-sequence spread spectrum radio (DSSS). In this case, step b) may be such as to re-allocate a first sub-bandwidth of DSSS associated with the low bandwidth usage access point to complement a second sub-bandwidth of DSSS associated with the high bandwidth usage access point, and the method further comprises the step of expanding the coverage of a third access point using the third sub-bandwidth of DSSS for data communication with the users of the access point previously operating under the first sub-bandwidth of DSSS.

Alternatively, the 802.11 wireless technology operates under frequency-hopping spread spectrum radio (FHSS). In this case, step b) may be such as to re-allocate at least one FHSS bandwidth channel from the low bandwidth usage access point to the high bandwidth usage access point.

The invention also provides a wireless LAN constituted by a plurality of access points each using the same wireless technology for data communication with users, wherein the LAN is provided with means for continuously monitoring bandwidth usage by each of the access points, and for re-allocating bandwidth from a low bandwidth usage access point to a high bandwidth usage access point.

### BRIEF DESCRIPTION OF THE DRAWINGS

The invention will now be described in greater detail, by way of example, with reference to the drawings, in which:—

FIG. 1 is a schematic representation of a hot spot which utilises DSSS technology; and

FIG. 2 is a schematic representation of a hot spot using FHSS technology.

### DESCRIPTION OF PREFERRED EMBODIMENTS

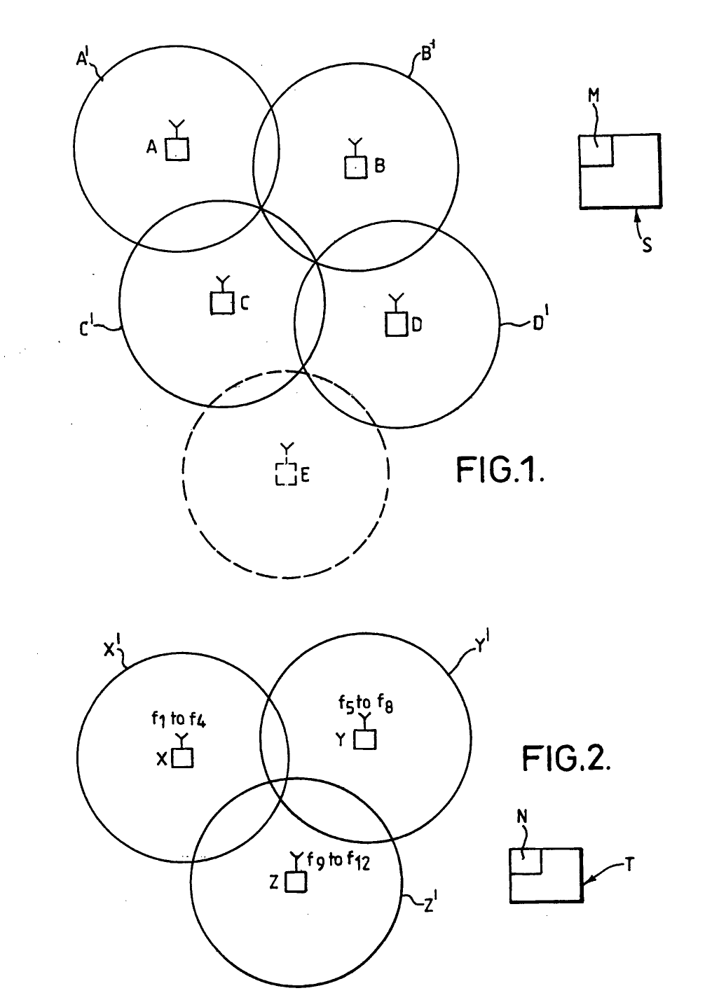

Referring to the drawings, FIG. 1 shows a hot spot having four access points A, B, C and D, the ranges of the access points being indicated by the circles A′, B′, C′ and D′. The access points A to D use the 802.11 wireless technology and operate under DSSS. In DSSS, a data signal at the sending station is combined with a higher data rate bit sequence, or chipping code, that divides the user data according to the spreading ratio. The chipping code is a redundant bit pattern for each bit that is transmitted, which increases the signal's resistance to interference. If one or more bits in the pattern are damaged during transmission, the original data can be recovered as a result of the redundancy of the transmission. A DSSS system spreads the power of the 2.4 GHz frequency band using mathematical coding functions. In practice, DSSS splits the total bandwidth of 802.11 into three equal sub-bandwidth channels.

In the hot spot of FIG. 1, each of the access points A, B and C is allocated one of the three sub-bandwidth channels, for example, the access point A may be allocated the first sub-bandwidth channel, the access point B the second sub-bandwidth channel and the access point C the third sub-bandwidth channel. The user within range of each of the access points A, B and C will, therefore, communicate with the relevant access points over the respective sub-bandwidth channel. Where the ranges of adjacent access points A, B and C overlap, users can communicate with one or more of the access points. Users within range of the access point D also communicate with that access point using the first sub-bandwidth channel rather than the second or third sub-bandwidth channel. This is because, as shown, the range of access point D overlaps the ranges of access points B and C, but does not overlap the range of the access point A. Consequently, there is no danger of interference from access point A for users within range of the access point D.

The hot spot is controlled by a control means associated either with one of the access points A to D separately (as indicated by the reference M). The control means M is preferably associated with a server S, to which the access points A to D are connected, conveniently by hard wiring. The control means M continuously monitors the consumption of the bandwidth channels in all areas, and will increase or decrease it in one or more areas in dependence on the number of users within those areas. For example, if the number of users within range of access point A increases substantially, and the number of users within range of the access point B reduces substantially, the second sub-bandwidth channel would be re-allocated to the access point A, and the access point C would be reconfigured by expanding its range to cover the users previously within range of the access point B.

As a DSSS system spreads the power out over a wider frequency band using mathematical coding functions, the widespread signal is correlated into a stronger signal at a receiver, so that any narrow band noise is spread widely. Thus, a system operating under DSSS is susceptible to interference to, for example, noise from microwaves. DSSS has, however, the advantage of a high throughput, and hence a high quality of service (QoS).

The arrangement described above with reference to FIG. 1 could be modified, for example by adding a fifth access point E (shown in dotted lines). This access point would operate using the second sub-bandwidth channel, as access points C and D use the first and third sub-bandwidth channels.

FIG. 2 is a schematic representation of a hot spot similar to that shown in FIG. 1, the hot spot having three access points X, Y and Z whose ranges are indicated by the lines X′, Y′ and Z′. In this case, each of the access points operates using 802.11 technology operating under FHSS. This is a technique that uses a time-varying narrow band signal to spread the radio frequency (RF) energy over a wide band. In practice, FHSS divides the 802.11 bandwidth into a large number of smaller bandwidth channels, and the system works by jumping from one frequency (bandwidth channel) to another in a random pattern, a short burst of data being transmitted at each of the frequencies. The technique reduces interference because a signal from a narrowband system will only affect the spread spectrum signal if both are transmitting at the same frequency at the same time. If transmitter and receiver are synchronised properly, a simple logical channel is maintained. The transmission frequencies are determined by a spreading, or hopping, code—the receiver must be set to the same hopping code and must listen to the incoming signal at the right time and correct frequency in order to receive the signal properly.

In the hot spot of FIG. 2, the access point X may be allocated four FHSS bandwidth channels f1 to f4, the access point Y may be allocated four bandwidth channels f5 to f8, and the access point Z may be allocated four bandwidth channels f9 to f12. In practice, each of the access points X, Y and Z would be allocated more bandwidth channels, but this system will be described as using only twelve channels for the sake of simplicity.

The hot spot is controlled by control means associated with one of the access points X-Z or separately (as indicated by the reference N). The control means N is preferably associated with a server T, to which the access points X, Y and Z are connected, conveniently by hard wiring. The control means N continuously monitors the consumption of the bandwidth channels in all areas, and will increase or decrease it in one or more areas in dependence on the numbers of users within those areas. For example, if the number of users within range of the access point X increases substantially, and the number of users within the range of the access point Y reduces substantially, the control means. N will re-allocate one or more of the bandwidth channels associated with that access point to the access point X. For example, bandwidth channels f7 and f8 may be re-allocated to the access point X. It should be noted that bandwidth channels adjacent to those associated with the access point X should not be re-allocated, as they are more likely to cause interference with the bandwidth channels already being deployed by the access point X. If further bandwidth is required in the area covered by the access point X, this could be accomplished by re-allocating, for example, bandwidth channels f9 and f10 from the access point Z.

The system described above with reference to FIG. 2 has advantages over that described with reference to FIG. 1 in that it gives greater flexibility, it being possible to allocate extra bandwidth in small, discrete amounts than the DSSS system. The FHSS system of FIG. 2 also suffers less from problems with noise, but it does have the disadvantage of having a smaller throughput and reduced QoS when compared with the DSSS system of FIG. 1. The choice of which system (DSSS or FHSS) to use is, therefore, dependent upon the requirements for throughput, QoS, flexibility and noise.

The choice of wireless technology used will depend upon the requirements of the LAN concerned. Thus, 802.11b can operate at up to 11 Mbps over a relatively wide area of coverage, and 802.11a can operate at up to 54 Mbps but over a narrower range of coverage. Moreover, with 802.11b, DSSS modulation allows up to the full data rate of 11 Mbps, whereas FHSS modulation allows a data rate of only 2 Mbps.

By continuously monitoring bandwidth using the control means M or N, “smart” allocation of bandwidth can be accomplished. This use of a centralised control system cuts down on the amount of on-air signalling traffic requesting varying amounts of bandwidth, and so increases the amount of on-air available bandwidth. Inevitably, the channel is asymmetric, that is to say a mobile device will usually be the requester of information (such as a web page), so that the amount of uplink traffic is small, but the downlink channel is large. Consequently, the control means M or N is better placed to reserve bandwidth efficiently for the mobiles in its coverage area.

1. A method of allocating bandwidths in a wireless LAN having a plurality of access points each using the same wireless technology for data communication with users, the method comprising the steps of:—
a) continuously monitoring bandwidth usage by each of the access points; and
b) re-allocating bandwidth from a low bandwidth usage access point to a high bandwidth usage access point.

2. A method as claimed in claim 1, wherein the access points each use the 802.11 wireless technology.

3. A method as claimed in claim 2, wherein the 802.11 wireless technology uses DSSS.

4. A method as claimed in claim 3, wherein step b) is such as to re-allocate a first sub-bandwidth of DSSS associated with the low bandwidth usage access point to complement a second sub-bandwidth of DSSS associated with the high bandwidth usage access point, and the method further comprises the step of expanding the coverage of a third access point using the third sub-bandwidth of DSSS for data communication with the users of the access point previously operating under the first sub-bandwidth of DSSS.

5. A method as claimed in claim 2, wherein the 802.11 wireless technology operates under FHSS.

6. A method as claimed in claim 5, wherein step b) is such as to re-allocate at least one FHSS bandwidth channel from the low bandwidth usage access point to the high bandwidth usage access point.

7. A wireless LAN constituted by a plurality of access points each using the same wireless technology for data communication with users, wherein the LAN is provided with means for continuously monitoring bandwidth usage by each of the access points, and for re-allocating bandwidth from a low bandwidth usage access point to a high bandwidth usage access point.

8. A LAN as claimed in claim 7, wherein the access points each use the 802.11 wireless technology.

9. A LAN as claimed in claim 8, wherein the 802.11 wireless technology uses DSSS.

10. A LAN as claimed in claim 9, wherein the monitoring and re-allocation means is such as to re-allocate a first sub-bandwidth of DSSS associated with the low bandwidth usage access point to complement a second sub-bandwidth of DSSS associated with the high bandwidth usage access point, and said means is such as to expand the coverage of a third access point using the third sub-bandwidth of DSSS for data communication with the users of the access point previously operating under the first sub-bandwidth of DSSS.

11. A LAN as claimed in claim 8, wherein the 802.11 wireless technology operates under FHSS.

12. A LAN as claimed in claim 11, wherein the monitoring and re-allocation means is such as to re-allocate at least one FHSS bandwidth channel from the low bandwidth usage access point to the high bandwidth usage access point.

13. A method of allocating bandwidths in a wireless LAN having a plurality of access points each using the 802.11, DSSS wireless technology for data communication with users, the method comprising the steps of:—
a) continuously monitoring bandwidth usage by each of the access points; and
b) re-allocating bandwidth from a low bandwidth usage access point to a high bandwidth usage access point; wherein
step b) is such as to re-allocate a first sub-bandwidth of DSSS associated with the low bandwidth usage access point to complement a second sub-bandwidth of DSSS associated with the high bandwidth usage access point, and the method further comprises the step of expanding the coverage of a third access point using the third sub-bandwidth of DSSS for data communication with the users of the access point previously operating under the first sub-bandwidth of DSSS.

14. A method of allocating bandwidths in a wireless LAN having a plurality of access points each using the 802.11, FSSS wireless technology for data communication with users, the method comprising the steps of:—
a) continuously monitoring bandwidth usage by each of the access points; and
b) re-allocating bandwidth from a low bandwidth usage access point to a high bandwidth usage access point; wherein
step b) is such as to re-allocate at least one FHSS bandwidth channel from the low bandwidth usage access point to the high bandwidth usage access point.

15. A wireless LAN constituted by a plurality of access points each using 802.11, DSSS wireless technology for data communication with users, wherein the LAN is provided with means for continuously monitoring bandwidth usage by each of the access points, and for re-allocating bandwidth from a low bandwidth usage access point to a high bandwidth usage access point; and wherein the monitoring and re-allocation means is such as to re-allocate a first sub-bandwidth of DSSS associated with the low bandwidth usage access point to complement a second sub-bandwidth of DSSS associated with the high bandwidth usage access point, and said means is such as to expand the coverage of a third access point using the third sub-bandwidth of DSSS for data communication with the users of the access point previously operating under the first sub-bandwidth of DSSS.

16. A wireless LAN constituted by a plurality of access points each using 802.11, FSSS wireless technology for data communication with users, wherein the LAN is provided with means for continuously monitoring bandwidth usage by each of the access points, and for re-allocating bandwidth from a low bandwidth usage access point to a high bandwidth usage access point; and wherein the monitoring and re-allocation means is such as to re-allocate at least one FHSS bandwidth channel from the low bandwidth usage access point to the high bandwidth usage access point.
